(19) United States
(12) Patent Application Publication
(10) Pub. No.: US 2008/0287573 A1
(43) Pub. Date: Nov. 20, 2008

(54) Ultra-Low Dielectrics Film for Copper Interconnect

(76) Inventors: Hee-Woo Rhee, Seoul (KR); Do Young Yoon, Seoul (KR); Kook Heon Char, Seoul (KR); Jin-Kyu Lee, Seoul (KR); Bongjin Moon, Kyunggi-do (KR); Sung-Kyu Min, Seoul (KR); Se Jung Park, Seoul (KR); Jae-Jin Shin, Seoul (KR)

Correspondence Address: Ronald R. Santucci;Frommer Lawrence & Haug, 745 Fifth Avenue, New York, NY, 10151, US

(21) Appl. No.: 10/581,165

(22) PCT Filed: May 12, 2004
(86) PCT No.: PCT/KR04/01092

§ 371 Date: May 31, 2006

(30) Foreign Application Priority Data
Dec. 1, 2003 (KR) 10-2003-0086244

(51) Int. Cl. C08K 5/1545

(52) U.S. Cl. 524/27

(57) ABSTRACT

The present invention relates to an ultra-low dielectric film for a copper interconnect, in particular, to an porous film prepared in such a manner that coating with an organic solution containing a polyalkyl silsesquioxane precursor or its copolymer as a matrix and acetylcyclodextrin nanoparticles as a template and then performing a sol-gel reaction and heat treatment at higher temperature. The present films may contain the template of up to 60 vol %, due to the use of acetylcyclodextrin, and have homogeneously distributed pores with the size of no more than 5 nm in the matrix. In addition, the present films exhibit a relatively low dielectric constant of about 1.5, and excellent interconnectivity between pores, so that they are considered a promising ultra-low dielectric film for a copper interconnect.

### BACKGROUND OF THE INVENTION

1. Field of the Invention

The present invention relates to an ultra-low dielectric film for a copper interconnect, in particular, to an porous film prepared by coating with an organic solution containing a polyalkyl silsesquioxane precursor or its copolymer as a matrix and acetylcyclodextrin nanoparticles as a template and followed by performing a sol-gel reaction and heat treatment at higher temperature. The present films may contain the template of up to 60 vol %, which is due to the selective use of acetylcyclodextrin, and have homogeneously distributed pores with the size of no more than 5 nm in the matrix. In addition, the present films exhibit an ultra low dielectric constant of about 1.5, and well-defined closed pores, so that thus being considered as a good ultra-low dielectric film for a copper interconnect.

2. Description of the Related Art

Due to the recent request for semiconductors to have the properties of high integration and high speed, the critical dimension is on the drastic decrease. Low dielectrics, fabricated with aluminum liner and silicone oxide membrane (SiO₂, k=4.0) and fluoro-silicone oxide membrane (k-=3.5) as interlayer dielectrics, have been recognized as an excellent semiconductor device having high integration and high performance. However, such low dielectrics show serious shortcomings that signal delay due to delay of RC [expressed as multiplying a resistance (R) of a liner by a capacitance (C) of interlayer dielectric], noise due to crosstalk and power waste become highly aggravated.

To overcome the shortcomings described above, it is imperative that the conventional aluminum liner be replaced with a copper liner to decrease the resistance of metal liners and ultra-low dielectrics having an ultra-low dielectric constant as insulator are developed.

Following the long-continued evaluations on physical properties and applicability to devices, SEMATECH (USA) has revealed that Black Diamond™ available from Applied Materials, Inc. is useful as low dielectrics to prepare a copper chip in the near future and is suitable in a dry film processing (CVD) with a dielectric constant of about 2.7, and has actually fabricated numerous devices using the material. For wet film processing (spin-on) with a dielectric constant of about 2.7, SiLK® organic polymer available from Dow Chemical, Inc. has been considered promising. However, the next-generation low dielectrics with a dielectric constant of below 2.2 have not been concluded yet to be applicable to preparation of copper chips.

In this regard, for decreasing the dielectric constant of low dielectrics, the following approach has been suggested. According to this approach, thermally-unstable organic material and inorganic matrix as an interlayer dielectric are mixed and allowed to have a sol-gel reaction to induce hardening of matrix, thereby preparing organic-inorganic nanohybrid. Thereafter, air with a dielectric constant of 1.0 is introduced into a low dielectric film by heat treatment at an elevated temperature (C. V. Nguyen, K. R. Carter, C. J. Hawker, R. D. Miller, H. W. Rhee and D. Y. Yoon, Chem. Mater., 11, 3080 (1999)). Here, it is known as essential that the interaction between inorganic matrix and organic porogen be excellent to prepare low dielectrics having pores with small size and homogeneous distribution. Therefore, pore-forming resins having excellent compatibility with low dielectric inorganic matrix now attract much of global interest. As a conventional porogen, hyperbranched polyester [C. Nguyen, C. J. Hawker, R. D. Miller and J. L. Hedrick, Macromolecules, 33, 4281 (2000)], ethylene-propylene-ethylene tri block copolymer (Tetronics™) [S. Yang, P. A. Mirau, E. K. Lin, H. J. Lee and D. W. Gidley, Chem. Mater., 13, 2762 (2001)] and polymethylmethacrylate-N,N-dimethylaminoethyl methacrylate copolymer [Q. R. Huang, W. Volksen, E. Huang, M. Toney and R. D. Miller, Chem. Mater., 14(9), 3676 (2002)] have been known. Some researchers have reported that nanoporous ultra-low dielectrics having a dielectric constant of below 2.0 have been successfully developed by using the porogens described above.

However, in preparing ultra-low dielectrics by using the porogens described above, if the content of porogen is low, its compatibility with inorganic matrix becomes better, and therefore, the size of pores becomes smaller and their distribution shows a homogeneous pattern. In contrast, if the content of porogen is high, its compatibility becomes deteriorated, thus causing agglomeration of porogen domains and also increasing the size and distribution of pores. Also, when porogen content is above a certain amount, an open pore structure in low dielectric film is formed; therefore, the limitation to porogen content could induce serious problems in terms of mechanical strength of film and process reliability.

Recently, nanoparticles have been suggested as a template to develop an ultra-low dielectric film exhibiting improved mechanical and dielectric properties and having pores with a relatively small size and a closed structure. In this connection, IBM has reported recently a method of preparing nano-sized organic particles comprising preparation of an organic precursor with functional groups for crosslinking, i.e., poly ε-caprolactone-co-acryloyloxycaprolactone, via ATRP (atom transfer radical polymerization, which is capable of controlling molecular weight; adding a radical initiator in solution with extremely low concentration (M is about 10⁻⁵) and elevating a reaction temperature, thereby expediting intramolecular-crosslinking [D. Mecerreyes, V. Lee, C. J. Hawker and R. D. Miller, Adv, Mater., 13(3), 204 (2001)]. Furthermore, it has been reported that the nanoparticles described above are mixed with polymethyl silsesquioxane matrix and allowed to go through a sol-gel reaction and heat treatment at an elevated temperature to form pores in the matrix with a size similar to those in bulky state before mixing. The results demonstrate that if nanoparticles exhibiting excellent compatibility are employed as a template, the agglomeration between nanoparticles does not occur in sol-gel reaction and the pores formed exist in a closed structure unlike those low dielectric films prepared using conventional porogens. However, the above-described material is disadvantageous in that its particle size must be controlled via molecular weight of an organic precursor and also it has a relatively low yield because the crosslinking proceeds in a diluted solution.

To solve the problems described above, recent researches attempt to use nano-sized organic particles themselves as templates, of which representative is cyclodextrin having three-dimensional cylindrical configuration. The size of cyclodextrin particle ranges from 1.4 to 1.7 nm and its terminal portions allows the introduction of various functional groups, so that it is very advantageous in view of the modulation of compatibility with matrix. The Samsung Advanced Institute of Technology has reported that low dielectric films prepared using the mixture of heptakis(2,3,6-tri-O-methyl)-β-cyclodextrin and cyclic silsesquioxane (CSSQ) shows the pore size similar to those in bulky state and closed pores when the content of cyclodextrin reaches about 40% [J. H. Yim, Y. Y. Lyu, H. D. Jeong, S. K. Mah, J. G. Park and D. W. Gidley, Adv. Funct. Mater., 13(5) (2003), Korean Patent Unexamined Publication No. 2002-75720]. Despite such good pore properties, the nanoporous CSSQ matrix shows a much higher dielectric constant than its theoretical value. Accordingly, the development of organic nanoparticles exhibiting much improved dielectric properties is in urgent need in order to prepare ultra-low dielectric materials having good mechanical properties, a closed pore structure and a low dielectric constant.

Meanwhile, it has been known that polymethyl silsesquioxane, one of low dielectric silicate matrices of spin-on types, has the formula of (CH₃—SiO_{1.5})ₙ and exhibits improved properties for interlayer dielectrics such as low dielectric constant (k=2.7) and stability to moisture and heat. However, when exposed to vigorous semiconductor processes such as chemical mechanical planarization (CMP), its film is liable to disruption due to its low mechanical strength. Further, as the pores introduced into the polymethyl silsesquioxane matrix are increased with a view to reducing dielectric constant, it is likely that more drawbacks would occur. For this reason, the present inventors have developed a novel polyalkyl silsesquioxane copolymer having improved mechanical properties and compatibility with porogen by copolymerization of alkyltrialkoxysilane, a monomer for polymerization of polymethyl silsesquioxane, with α,ω-bistrialkoxysilyl compound as a comonomer [Korean Patent Unexamined Publication No. 2002-38540].

To overcome the shortcomings of conventional ultra-low dielectrics described above, the present inventors have conducted extensive researches, and as a result, found that the use of polyalkyl silsesquioxane precursors or their copolymers as a matrix while the use of acetylcyclodextrin nanoparticles as a pore-forming template permitted incorporation of excess template of about 60 vol % due to excellent compatibility between two components, thereby the films prepared therefrom exhibiting significant porosity and dielectric properties. The present dielectric films having smaller-sized pores and exhibiting closed pores are very useful in interlayer dielectrics for a copper interconnect.

Accordingly, it is an object of this invention to provide an ultra-low dielectric film for a copper interconnect.

### DETAILED DESCRIPTION OF THIS INVENTION

In the present invention, we invented an ultra-low dielectric film for a copper interconnect using an organic or inorganic matrix and a cyclodextrin-based template for pore formation. The improvement comprises the preparation of the ultra-low dielectric film by coating with an organic-inorganic mixed solution, wherein 40-70 vol % of a polyalkyl silsesquioxane precursor or its copolymer as the matrix, and 30-60 vol % of acetylcyclodextrin nanoparticles as the template, is contained in an organic solvent, respectively, and performing a sol-gel reaction and heat treatment.

The present invention will be described in more detail as follows.

The present invention relates to an ultra-low dielectric film having the maximum porosity of 60% and minimum dielectric constant of 1.5, which was prepared using a polyalkyl silsesquioxane precursor or its copolymer as a matrix and acetylcyclodextrin nanoparticles as a pore-forming template. The feature of the present invention lies in the use of acetylcyclodextrin nanoparticles as a pore-forming template for preparing an ultra-low dielectric film with a matrix of a polyalkyl silsesquioxane precursor or its copolymer, so that the content of templates is permitted to increase to 60 vol % from the conventional level, below 40 vol %, resulting in the significant improvement of maximum porosity and dielectric properties.

The present ultra-low dielectric film will be described in more detail as follows:

As a matrix component in the present invention, the polyalkyl silsesquioxane precursor or its copolymer exhibits excellent property in the compatibility with acetylcyclodextrin as a pore-forming template.

The polyalkyl silsesquioxane copolymer serving as a matrix includes a copolymer of alkyltrialkoxysilane and α,ω)-bistrialkoxysilylalkane, for example, a copolymer of methyltrimethoxysilane and α,ω-bistrimethoxysilylethane and a copolymer of methyltrimethoxysilane and α,ω-bistriethoxysilylethane. In particular, the polyalkyl silsesquioxane copolymer as a matrix component developed by the present inventors (Korean Patent Unexamined Publication No. 2002-38540) ensures the improved porosity and dielectric properties.

The polyalkyl silsesquioxane copolymer developed by the present inventors may be prepared by copolymerizing in a mixed solvent of organic solvent/water alkyltrialkoxy silane monomer represented by Formula 1 and α,ω-bistrimethoxysilyl monomer represented by Formula 2 in the presence of acid catalyst. It exhibits excellent physical properties and compatibility with template, inter alia, acetylcyclodextrin.

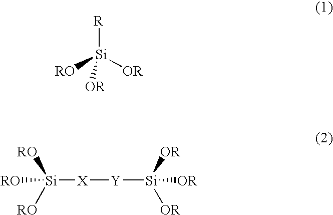

wherein R may be same or different and represents a C1-C6 alkyl group; and X and Y may be same or different and represent a C1-C6 alkylene group.

The present invention employs acetylcyclodextrin nanoparticles as a pore-forming template. Although Korean Patent Unexamined Publication No. 2002-38540 discloses cyclodextrin derivatives, it does not teach acetylcyclodextrin as a template but only show Examples using heptakis(2,3,6-tri-O-methyl)-p-cyclodextrin (HTM-β-CD), which is incorporated in the content of no more than 40 wt %. In contrast, the present invention selects acetylcyclodextrin as templates and incorporates acetylcyclodextrin up to 60 vol % in the content.

Acetylcyclodextrin for a pore-forming template in this invention may be represented by the following Formula 3:

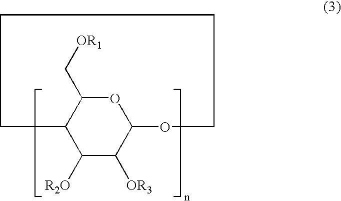

wherein n is an integer of 6-8; R₁, R₂ and R₃ is independently a hydrogen atom or an acetyl group; and at least one of R₁, R₂ and R₃ is an acetyl group.

Exemplary aetylcyclodextrin represented by the formula 3 includes triacetyl-α-cyclodextrin, triacetyl-β-cyclodextrin, triacetyl-γ-cyclodextrin, diacetyl-α-cyclodextrin, diacetyl-β-cyclodextrin, diacetyl-γ-cyclodextrin, monoacetyl-α-cyclodextrin, monoacetyl-β-cyclodextrin and monoacetyl-γ-cyclodextrin.

The process for preparing the ultra-low dielectric film of this invention will be described in more detail as follows:

First, polyalkyl silsesquioxane precursor or its copolymer as a matrix component and acetylcyclodextrin as a template are dissolved in an organic solvent and mixed to produce an organic-inorganic mixed solution. Here, examples of the above useful organic solvent include dimethylformamide (DMF), dimethylacrylamide (DMA) and dimethylsulfoxide (DMSO).

Thereafter, the organic-inorganic mixed solution prepared by passing through a polytetrafluoroethylene syringe filter (0.2 μm) is added dropwise onto a substrate and spin-coating is carried out at 2000-4000 rpm for 20-70 sec to prepare a film. As a substrate, conventional substrates may be used, preferably, silicone wafer. Thus the prepared films are subjected to curing at 200-400° C. to remove the residual organic solvent and trigger the condensation of silanol groups of the matrix, followed by allowing it to stand for 1 hr at 350-500° C. to finally prepare nanoporous ultra-low dielectric film. The hardening and removal of organic materials are performed under nitrogen atmosphere and the increase and heating and cooling rates are 3° C./min.

Thus prepared ultra-low dielectric film has the maximum porosity of 60% and the minimum dielectric constant of 1.5 and is very useful as a dielectric film for a copper interconnect.

### BRIEF DESCRIPTION OF THE DRAWINGS

FIG. 1 is a graph representing the comparisons of ultra-low dielectric films of the present invention and prior art with regard to porosity and dielectric properties.

The following specific examples are intended to be illustrative of the invention and should not be construed as limiting the scope of the invention as defined by appended claims.

### EXAMPLE 1

### Preparation of Polymethyl Silsesquioxane Copolymer

HCl solution and distilled water were injected into a solution of methylisobutylketone (MIBK) containing methyltrimethoxysilane [CH₃Si(OCH₃)₃] and then α,ω-bistrimethoxysilyethane [(CH₃O)₃Si—CH₂—CH₂—Si(OCH₃)₃, BTMSE] was added dropwise to the resultant and allowed to react, followed by removal of the solvent and HCl catalyst. Finally, polymethyl silsesquioxane copolymers showing BTMSE content of 10 mol %, Mw 2426, Mn 2,700 and Si—OH/Si atom ratio=27% were produced.

### EXAMPLE 2

### Preparation of Ultra-Low Dielectric Film Having Nanopores

The ultra-low dielectric film was prepared using polymethyl silsesquioxane (MSSQ) monopolymer, copolymer of methyltrimethoxysilane and α,ω-bistrimethoxysilyethane (BTESE 10%) or copolymer of methyltrimethoxysilane and α,ω-bistriethoxysilyethane (BTESE 25) as a matrix component and triacetyl-β-cyclodextrin as a template.

Each of the matrix component and template was dissolved in DMF organic solvent and mixed at a ratio indicated in Table 1 to obtain an organic-inorganic mixed solution. Through a polytetrafluoroethylene (PTFE) syringe filter (0.2 μm), the organic-inorganic mixed solution was added dropwise onto silicon wafers and spin-coating was carried out at 3500 rpm for 50 sec to prepare a film. Thus prepared film was subjected to curing at 250° C. to remove the organic solvent and induce the condensation of the inorganic matrix, followed by the heat treatment for 1 hr at 430° C. to finally prepare nanoporous ultra-low dielectric film. The hardening the inorganic matrix and removal of organic materials were performed under nitrogen atmosphere and the increase and decrease of temperature were executed at the rate of 3° C./min.

The physical properties of the films prepared according to procedures described above were analyzed, the results of which are summarized in Table 1.

### EXPERIMENTAL EXAMPLE 1

### Measurement of Refractive Index, Porosity and Dielectric Constant of Films

Refractive index and thickness of thin films prepared in Example 2 were measured at a wavelength of 632.8 nm with an ellipsometer (L166C, Gaertner Scientific Corp.).

Film porosity was calculated according to the Lorentz-Lorentz equation represented by the Equation 1,

$$\frac{{n}_{s} - 1}{{n}_{s} + 2} = ( 1 - p ) \frac{{n}_{r} - 1}{{n}_{r} + 2} \qquad Equation 1$$

wherein nₛ and nᵣ are refractive indices of porous and non-porous films, respectively, and p represents porosity.

The measurement of dielectric constant of thin films was preformed according to the following procedures: Onto a bottom electrode of the silicone wafer (0.008 Ω□m) with high conductivity, the ultra-low dielectric film prepared in Example 2 and then Al electrodes with a diameter of about 1 mm for a top electrode were deposited by electron beam evaporation method. The electrostatic capacitance of the specimens thus obtained were analyzed using HP 4194A impedence analyzer at a frequency of 1 MHz and then dielectric constants were calculated with the data of film thickness and electrode area. Further, the theoretical dielectric constants were calculated according to the Maxwell-Garnett equation of the following Equation 2:

$$\frac{{k}_{s} - 1}{{k}_{s} + 2} = ( 1 - p ) \frac{{k}_{r} - 1}{{k}_{r} + 2} \qquad Equation 2$$

wherein kₛ and kᵣ are dielectric constants of porous and non-porous films, respectively, and p represents porosity.

TABLE 1

| Component | Acetyl- | Thick- | | | | |
|---|---|---|---|---|---|---|
| of | cyclodextrin | ness | Refractive | Porosity | Dielectric constant (k) | |
| Matrix | (vol %) | (Å) | index | (%) | Expected | Measured |
| Polymethyl | 0 | 2998 | 1.371 | 0 | 2.7 | 2.7 |
| silsesquioxane | 10 | 3011 | 1.337 | 10.1 | 2.41 | 2.43 |
| (MSSQ) | 20 | 2932 | 1.290 | 20.2 | 2.16 | 2.19 |
| | 30 | 2869 | 1.259 | 28.3 | 1.98 | 1.95 |
| | 40 | 2817 | 1.209 | 41.3 | 1.74 | 1.71 |
| Polymethyl | 0 | 2918 | 1.402 | 0 | 2.87 | 2.87 |
| silsesquioxane | 10 | 2888 | 1.362 | 9.1 | 2.60 | 2.62 |
| bicopolymer | 20 | 2845 | 1.310 | 20.7 | 2.29 | 2.31 |
| (BTMSE 10%) | 30 | 2806 | 1.284 | 26.3 | 2.14 | 2.17 |
| | 40 | 2778 | 1.230 | 39.2 | 1.87 | 1.89 |
| | 50 | 2746 | 1.180 | 50.2 | 1.64 | 1.66 |
| | 60 | 2523 | 1.150 | 59.2 | 1.52 | 1.55 |
| Polymethyl | 0 | 2723 | 1.373 | 0 | 3.0 | |
| silsesquioxane | 10 | 2569 | 1.345 | 7.1 | 2.74 | |
| bicopolymer | 20 | 2817 | 1.315 | 14.2 | 2.50 | |
| (BTESE 25%) | 30 | 2442 | 1.282 | 20.2 | 2.28 | |
| | 40 | 2325 | 1.206 | 40.6 | 1.86 | |

BTMSE: α,ω-bistriethoxysilylethane

### EXPERIMENTAL EXAMPLE 2

### Comparison of Porosity and Dielectric Properties for Different Templates

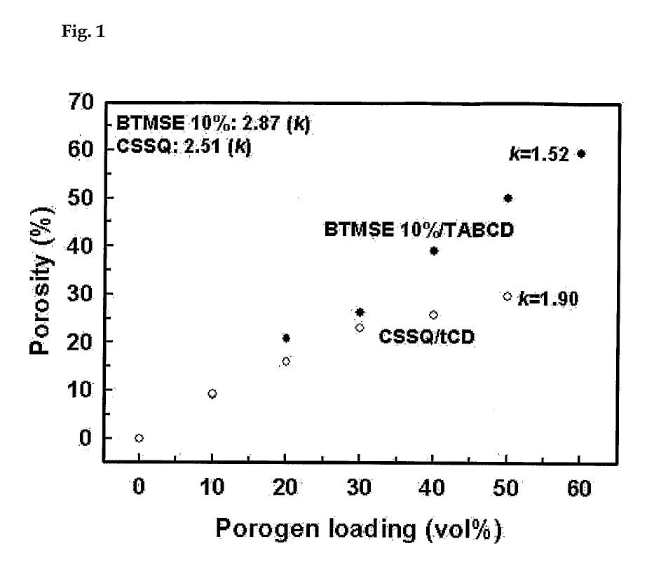

The porosities and dielectric properties depending on the content of templates for the ultra-low dielectric films of the present invention and Korean Patent Unexamined Publication No. 2002-75720 were analyzed and represented in FIG. 1.

The ultra-low dielectric films of the present invention were prepared using polymethyl silsesquioxane bicopolymer (Example 1, containing 10% of BTMSE) and triacety-β-cyclodextrin nanoparticles (TABCD) as templates for 0, 10, 20, 30, 40, 50 and 60 vol %. The comparative films were prepared using cyclic silsesquioxane (CSSQ) and heptakis(2,3,6-tri-O-methyl)-β-cyclodextrin [tCD] as templates of 0, 10, 20, 30, 40 and 50 vol %.

FIG. 1 shows that the porosities and dielectric constants become distinctly different as the content of the template loading exceeds 30 vol %.

As described previously, the ultra-low dielectric films of this invention exhibit excellent porosity and dielectric properties and have smaller-sized close pores, which is due to the use of acetylcyclodextrin nanoparticles having good compatibility with a polyalkyl silsesquioxane precursor or its copolymer as a matrix. In this regard, the present ultra-low dielectric films are very useful as interlayer dielectrics for a copper interconnect.

Having described a preferred embodiment of the present invention, it is to be understood that variants and modifications thereof falling within the spirit of the invention may become apparent to those skilled in this art, and the scope of this invention is to be determined by appended claims and their equivalents:

1. In an ultra-low dielectric film for a copper interconnect prepared using an organic or inorganic matrix and a cyclodextrin-based template for pore formation, the improvement comprises: said ultra-low dielectric film is prepared by coating with an organic-inorganic mixed solution containing in an organic solvent 40-70 vol % of a polyalkyl silsesquioxane precursor or its copolymer as the matrix and 30-60 vol % of acetylcyclodextrin nanoparticles as the template.

2. The ultra-low dielectric film for a copper interconnect according to claim 1, wherein said polyalkyl silsesquioxane copolymer is a copolymer of alkyltrialkoxysilane and α,(-bistrialkoxysilylalkane.

3. The ultra-low dielectric film for a copper interconnect according to claim 2, wherein said polyalkyl silsesquioxane copolymer is a copolymer of methyltrimethoxysilane and (,(-bistrimethoxysilylethane or a copolymer of methyltrimethoxysilane and (,(-bistriethoxysilylethane.

4. The ultra-low dielectric film for a copper interconnect according to claim 1, wherein said acetylcyclodextrin is represented by the following formula 3: 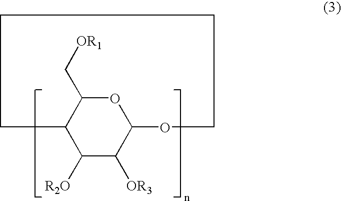
wherein n is an integer of 6-8; R1, R2 and R3 are independently a hydrogen atom or an acetyl group; and at least one of R1, R2 and R3 is an acetyl group.

5. The ultra-low dielectric film for a copper interconnect according to claim 4, wherein said acetylcyclodextrin is selected from the group consisting of triacetyl-α-cyclodextrin, triacetyl-β-cyclodextrin, triacetyl-γ-cyclodextrin, diacetyl-α-cyclodextrin, diacetyl-β-cyclodextrin, diacetyl-γ-cyclodextrin, monoacetyl-α-cyclodextrin, monoacetyl-β-cyclodextrin and monoacetyl-γ-cyclodextrin.

6. The ultra-low dielectric film for a copper interconnect according to claim 1, wherein said organic solvent is selected from the group consisting of dimethylformamide (DMF), dimethylacrylamide (DMA) and dimethylsulfoxide (DMSO).

7. The ultra-low dielectric film for a copper interconnect according to claim 1, wherein said ultra-low dielectric film has a maximum porosity of 60% and a minimum dielectric constant of 1.5.

8. The ultra-low dielectric film for a copper interconnect according to claim 2, wherein said ultra-low dielectric film has a maximum porosity of 60% and a minimum dielectric constant of 1.5.

9. The ultra-low dielectric film for a copper interconnect according to claim 3, wherein said ultra-low dielectric film has a maximum porosity of 60% and a minimum dielectric constant of 1.5.

10. The ultra-low dielectric film for a copper interconnect according to claim 4, wherein said ultra-low dielectric film has a maximum porosity of 60% and a minimum dielectric constant of 1.5.

11. The ultra-low dielectric film for a copper interconnect according to claim 5, wherein said ultra-low dielectric film has a maximum porosity of 60% and a minimum dielectric constant of 1.5.

12. The ultra-low dielectric film for a copper interconnect according to claim 6, wherein said ultra-low dielectric film has a maximum porosity of 60% and a minimum dielectric constant of 1.5.
